(19) United States
(12) Patent Application Publication
(10) Pub. No.: US 2006/0168728 A1
(43) Pub. Date: Aug. 3, 2006

(54) Bariatric patient management system

(76) Inventors: Frederic W Strobel, MONTPELIER, OH (US); Steven W Cotter, Bryan, OH (US)

Correspondence Address: FRASER MARTIN & MILLER LLC, 28366 KENSINGTON LANE, PERRYSBURG, OH, 43551, US

(21) Appl. No.: 10/541,041

(22) PCT Filed: Dec. 23, 2003
(86) PCT No.: PCT/US03/41169

§ 371 Date: Dec. 12, 2005

Related U.S. Application Data
(60) Provisional application No. 60/436,555, filed on Dec. 26, 2002.

(51) Int. Cl. A61G 7/015

(52) U.S. Cl. 5/618; 5/600

(57) ABSTRACT

A bariatric bed having extensible side portions and extensible end portions which facilitate an expansion of the overall width and length of the bed to comfortably support an obese patient, the side portions capable of being retracted to reduce the overall width of the bed to fit through a standard hospital door opening, the bed including a plurality of load cells which transmit a signal to a weigh scale to provide a readout of the weight of the patient.

### CROSS-REFERENCE TO RELATED APPLICATION

This application claims the benefit of U.S. provisional patent application Ser. No. 60/436,555, filed Dec. 26, 2002.

### FIELD OF THE INVENTION

The present invention relates to a patient management system and more particularly to a bariatric patient management system having extensible side portions and extensible end portions which expand the width and length of the system to facilitate supporting an obese patient.

### BACKGROUND OF THE INVENTION

A growing number of people are becoming obese to the point bariatric surgery becomes necessary for the patient to lose weight and avoid a life of obesity. While the trend toward obesity concerns health experts throughout the world, obesity is being treated by bariatric surgery. Such surgery procedure involves the sealing off of eighty-five percent (85%) of the patient's stomach. In such procedures, it is necessary to support the patient during the surgical procedure and transport the patient before and after the surgical procedure and during convalescence.

Bariatrics is typically defined as the branch of medicine concerned with the management of obesity and allied diseases. The above referred example of bariatric surgery is only one of the examples of an instance where it becomes necessary to support persons of considerable weight. It has been found necessary to deal with persons weighing up to and exceeding one thousand pounds.

Accordingly, it has become necessary to develop beds, stretchers, chairs, and/or tables capable of supporting the weight of persons weighing up to and exceeding one thousand pounds.

Typically, a standard hospital bed can be adjusted to control both mattress contour and height above the floor. The standard hospital bed is rated for approximately 350 pounds of weight. When it is necessary for the hospital bed to be moved, it is transported by rolling on casters. The standard hospital bed is typically 39inches wide so as to fit through a standard hospital door.

The bariatric bed must have the capabilities of the standard hospital bed. That is, the bariatric bed is capable of adjusting the contours of the mattress and raising or lowering the elevation of the mattress above the floor. However, the bariatric bed is typically wider than the standard hospital bed, thus restricting the mobility of the bariatric bed within the hospital. The bariatric bed can be as wide as 60-inches, thus being much wider than the standard hospital door.

It would be desirable to produce a bariatric bed which combines a full array of functions including: flat, seated, reclining, and trendelenburg positions for patient transfer, transportation, examination, treatment, surgery, procedural, and cardiac chair position, and wherein the mobility of the bariatric bed is maximized.

### SUMMARY OF THE INVENTION

Consistent and consonant with the present invention, a bariatric bed which combines a full array of functions including: flat, seated, reclining, and trendelenburg positions for patient transfer, transportation, examination, treatment, surgery, procedural, and cardiac chair position, and wherein the mobility of the bariatric bed is maximized, has surprisingly been discovered.

The bariatric patient support system comprises: a body supporting main frame having a mattress supporting surface, the main frame including at least one of an extensible side pull out extension and an extensible end pull out extension to increase an area of the mattress supporting surface; a plurality of ground engaging wheels disposed on the mainframe to facilitate a transporting of the bariatric patient management system; and a plurality of actuators to effect a change in a contour of the mattress supporting surface of the main frame.

### BRIEF DESCRIPTION OF THE DRAWINGS

The above, as well as other objects, features, and advantages of the present invention will be understood from the detailed description of the preferred embodiments of the present invention with reference to the accompanying drawings, in which:

FIG. 1 is a top perspective view of a bariatric patient management system for supporting a bariatric patient in accordance with the present invention;

FIG. 2 is a side elevational view of the bariatric patient management system illustrated in FIG. 1, and showing a trapeze suspended from a boom assembly;

FIG. 3 is a bottom perspective view of the bariatric patient management system illustrated in FIG. 1;

FIG. 4 is a partial exploded perspective view of the bariatric patient management system illustrated in FIG. 1;

FIG. 5 is a partial exploded perspective view of the bariatric patient management system illustrated in FIGS. 1, 2, and 3 showing the boom assembly for the bariatric bed;

FIG. 6 is a partial perspective view of the bariatric patient management system illustrated in FIGS. 1, 2, 3, and 4 showing a pull out extension;

FIG. 7 is a partial exploded perspective view of a load cell and wheel assembly for the bariatric patient management system illustrated in FIG. 1; and

FIG. 8 is a side elevational view of the load cell and wheel assembly illustrated in FIG. 7.

### DETAILED DESCRIPTION OF THE PREFERRED EMBODIMENT

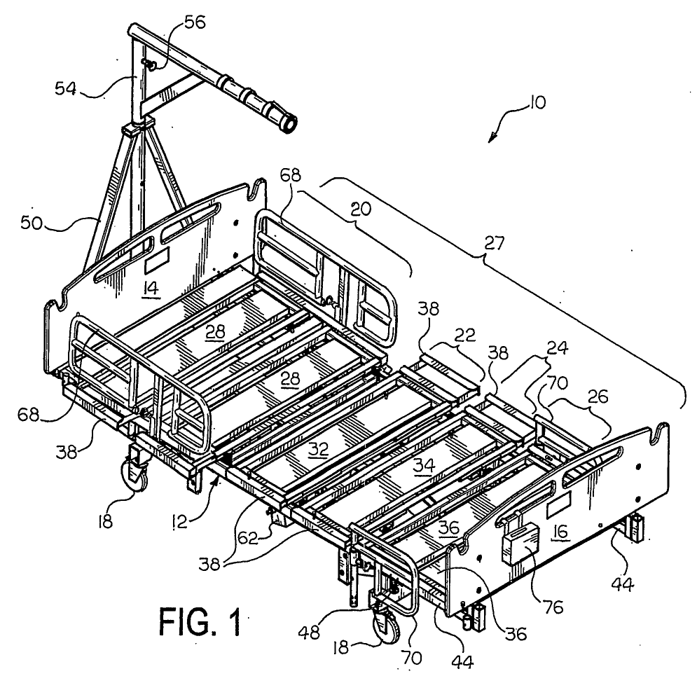

Referring now to FIG. 1, there is shown generally at 10 a top perspective view of a bariatric patient management system or bed in accordance with the present invention. The bariatric patient management system 10 includes a body supporting main frame 12, a headboard 14, a footboard 16, and ground engaging wheels or casters 18 for supporting a patient, as clearly illustrated in FIGS. 1, 2, 3, and 4.

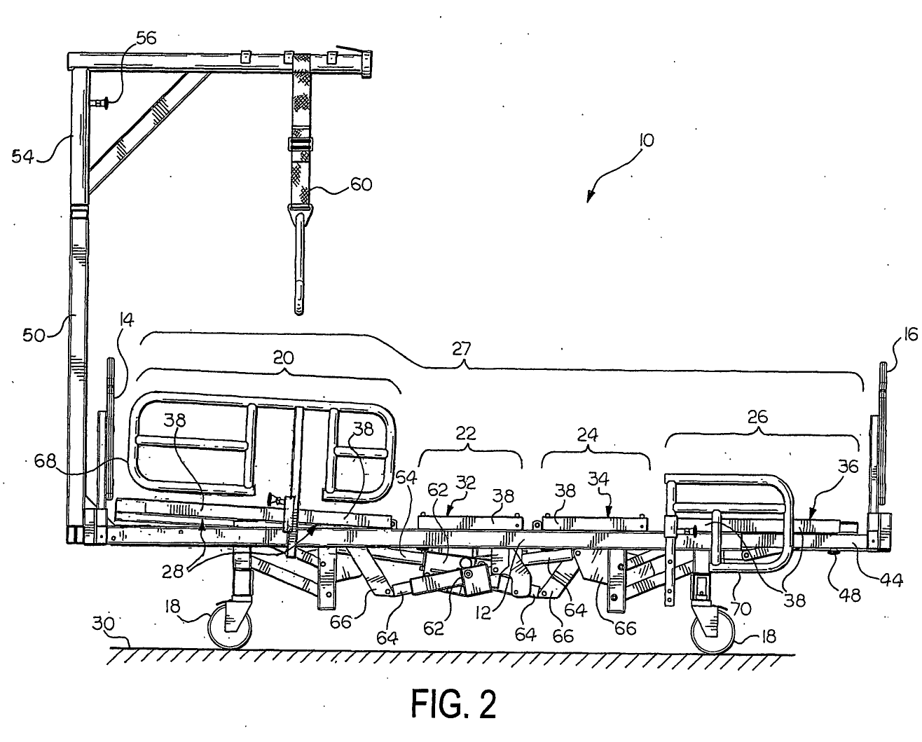

The main frame 12 can be of solid or split construction and includes a backrest section 20, a middle section 22, a leg section 24, and a foot section 26 disposed thereon. The backrest section 20, the middle section 22, the leg section 24, and the foot section 26 cooperate to form a mattress supporting surface 27 for the bariatric patient management system 10. The backrest section 20 includes a pair of backrest panels 28. A substantially planar surface is formed by the backrest panels 28. In the position shown in FIGS. 1 and 2, the backrest panels 28 are parallel with a supporting surface 30 such as a floor, for example. Each of the middle section 22, the leg section 24, and the foot section 26 includes at least one respective middle panel 32, leg panel 34, and foot panel 36.

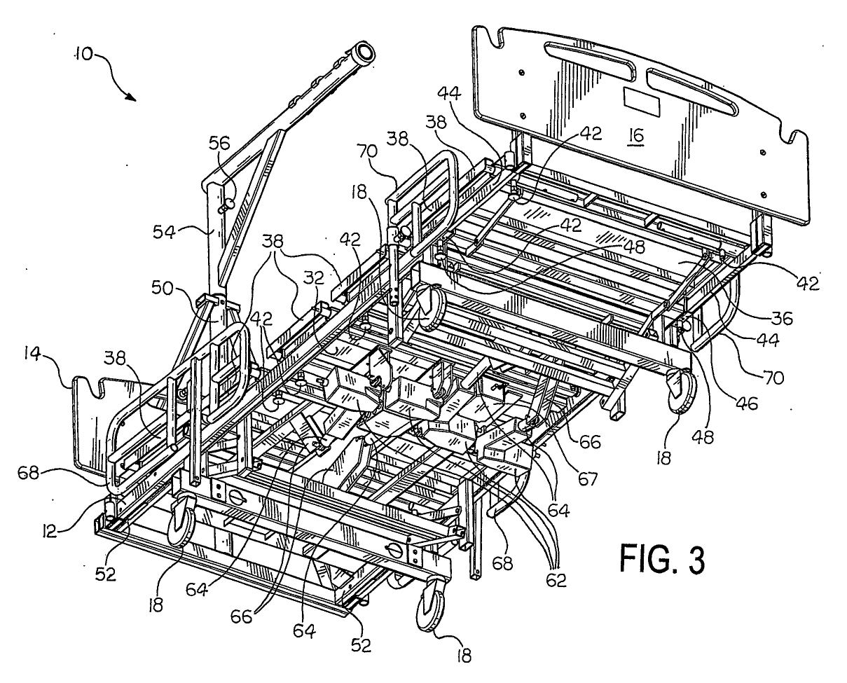

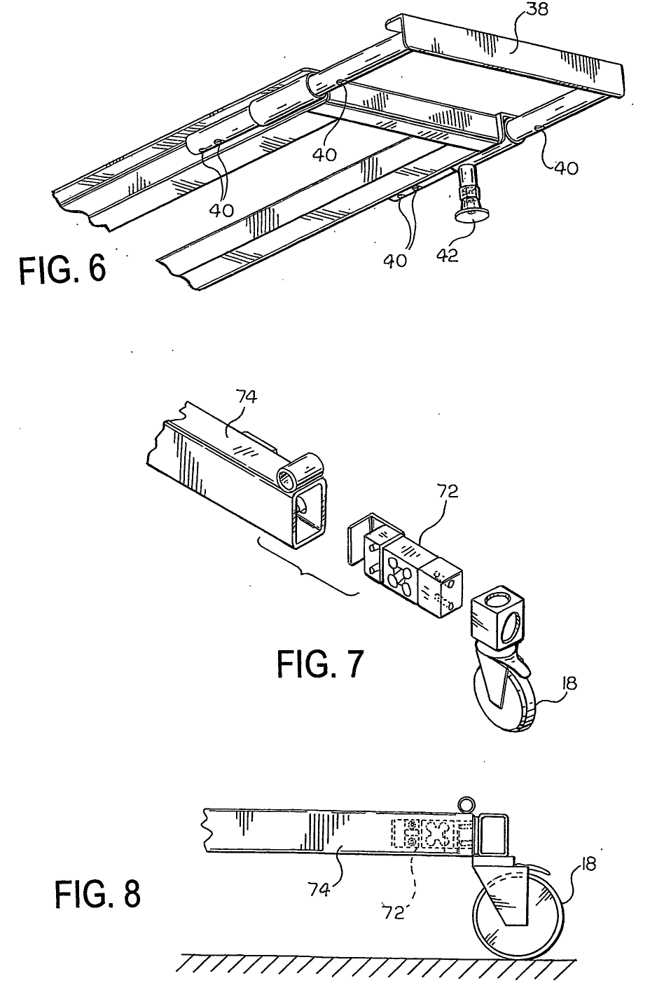

Both a first side and a second side of each of the backrest section 20, the middle section 22, the leg section 24, and the foot section 26 include an extensible side pull out extension 38. In the embodiment shown, the side pull out extension 38 telescopes outwardly. FIG. 6 shows a partial perspective view of the side pull out extension 38. A plurality of locking apertures 40 are disposed in the side pull out extension 38. A spring loaded locking pin 42 is disposed on the respective sections 20, 22, 24, 26 and cooperates with the apertures 40 to lock the side pull out extension 38 in a desired position. Other locking means may be used without departing from the scope and spirit of the invention. An extensible end pull out extension 44 is provided at an end of the main frame 12 adjacent the foot section 26. As illustrated in the drawings, the end pull out extension 44 telescopes outwardly. Referring to FIG. 3, a plurality of locking apertures 46 are show which are disposed in the end pull out extension 44. A spring loaded locking pin 48 is disposed on the main frame 12 and cooperates with the apertures 46 to lock the end pull out extension 44 in a desired position, clearly shown in FIGS. 1-4. Other locking means may be used without departing from the scope and spirit of the invention. An extensible end pull out extension 44 can also be provided at an end of the main frame 12 adjacent the backrest section 20.

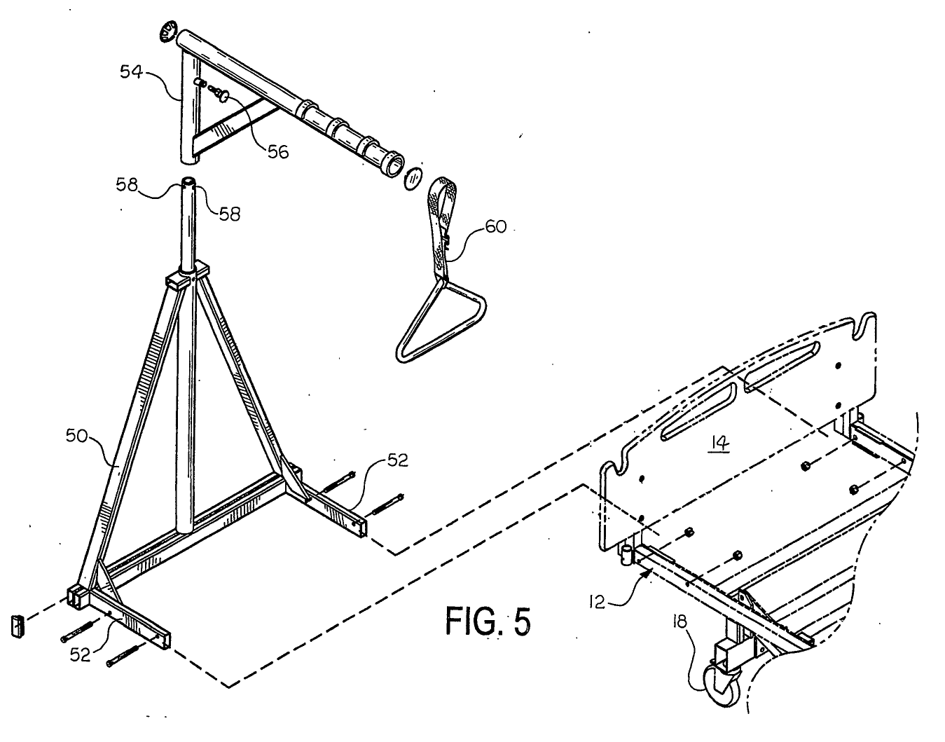

A trapeze base frame 50 is disposed on an end of the main frame 12 adjacent the backrest section 20. As shown in FIG. 5, outwardly extending arms 52 of the trapeze base frame 50 are received adjacent the main frame 12 and fastened thereto by any conventional fastening method such as threaded fasteners, for example. The trapeze base frame 50 and the arms 52 cooperate to facilitate a two-point mounting configuration. Common four-point mounting configurations require two additional mounting columns which obstruct access to the bariatric patient management system 10. A trapeze boom 54 is pivotally received on the trapeze base frame 50. A spring loaded locking pin 56 cooperates with apertures 58 formed in the trapeze base frame 50 to lock the trapeze boom 54 in a desired position. A trapeze bar assembly 60 depends from the trapeze boom 54.

Referring now to FIG. 2 and 3, there is shown a plurality of actuators 62. Each of the actuators 62 includes an actuator arm 64 which is operatively engaged with a linkage member 66. The linkage member 66 operatively links the actuator arm 64 with a respective one of the backrest section 20, the leg section 24, the foot section 26, and the main frame 12 to cause an inclination of the respective one of the backrest section 20, the leg section 24, the foot section 26, and the main frame 12 upon actuation of the actuator arm 64. A controller 67 is provided to control actuation of the actuators 62. The actuators 62 can be a push type actuator, a pull type actuator, or a push/pull type actuator as desired. In the embodiment shown, the actuators 62 are push/pull type actuators. It is understood that electrical actuators, hydraulic actuators, a combination thereof, or other actuators can be used without departing from the scope and spirit of the invention.

FIGS. 1-4 show a pair of side rails 68 adjustably connected to each side of the main frame 12 adjacent the backrest section 20 for the safety of the patient. The side rails 68 can be place in multiple positions. To facilitate transport, the side rails 68 can be dropped down into the main frame 12 to facilitate a width of 39 inches to fit through a standard 42-inch door. An ingress/egress bar 70 is pivotally mounted to each side of the main frame 12 adjacent the foot section 26 to assist with ingress and egress of the patient for the bariatric patient management system 10.

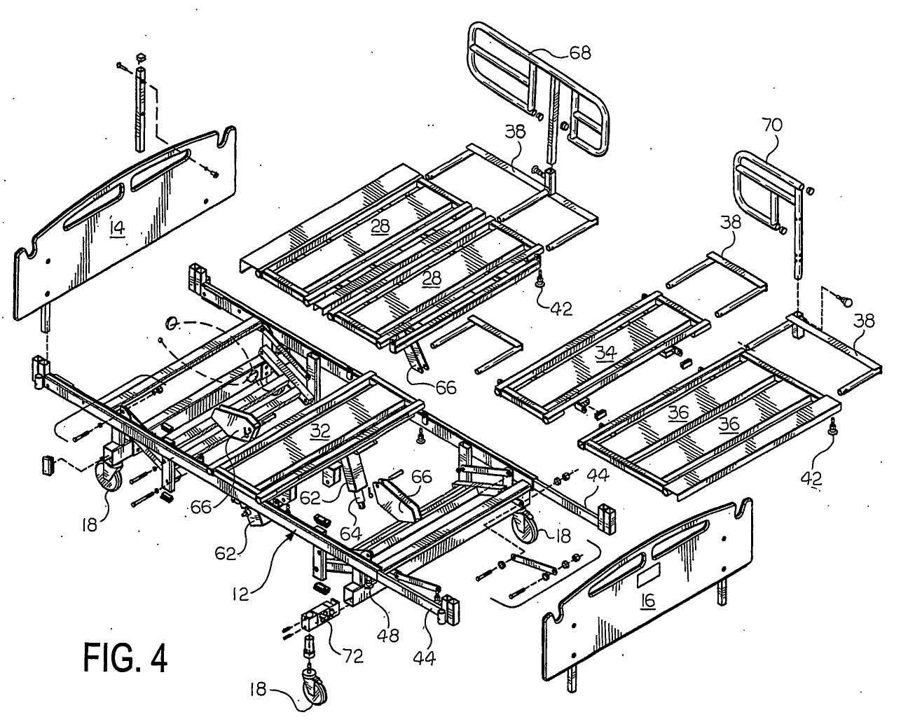

A load cell 72 is connected to each of the wheels 18 as illustrated in FIG. 4. FIG. 7 shows a partial exploded perspective view and FIG. 8 shows a side elevational view of the load cell 72 and the wheel 18. A cross member 74 is connected to the main frame 12. The load cell 72 is disposed in the cross member 74 and the wheel 18 is connected to the load cell 72 by any conventional fastening method such as threaded fasteners, for example. Thus, the load of the bariatric patient management system 10 is transmitted through the load cell 72. The load cell 72 is electrically connected to a weight display unit 76, as shown in FIG. 1, such that a weight signal sent from the load cell 72 to the weight display unit 76 can be shown.

In operation, the bariatric patient management system 10 can be configured in a plurality of positions. The actuators 62 can be used to raise and lower the backrest section 20, the leg section 24, the foot section 26, or any combination thereof. Additionally, the bariatric patient management system 10 height can be raised or lowered. A trendelenburg position and a reverse trendelenburg position are also facilitated by operation of the actuators 62. The bariatric patient management system 10 can be configured as a chair to place the patient in a seated position.

The trapeze boom 54 is pivotally received on the trapeze base frame 50. Thus, during patient evaluation or ingress/egress, the trapeze boom 54 can be pivoted to the side to a position as desired. The spring loaded locking pin 56 cooperates with the apertures 58 to lock the trapeze boom 54 in the desired position.

Use of the side pull out extensions 38 facilitates a widening and narrowing of the mattress supporting surface 27 of the bariatric patient management system 10. Use of the end pull out extension 44 facilitates a lengthening and shortening of the mattress supporting surface 27 of the bariatric patient management system 10. The ability to change the length and width of the bariatric patient management system 10 facilitates a larger patient, thus maximizing the comfort of the patient. The ability to change the length and width of the bariatric patient management system 10 also facilitates transport of the bariatric patient management system 10 as desired. During times of emergency or evacuation, health care providers may not have the time necessary to transfer a patient to a wheel chair or other transporting device. By providing a quick and easy adjustment method, safety and flexibility of transport are maximized.

The bariatric patient Management system 10 can also be provided with an optional 24-volt electric powered drive wheel (not shown) disposed on at least one of the wheels 18 to assist the health care provider during transport of the patient. Other features provided include special openings provided in the headboard 14 and the footboard 16 to mount patient various devices such as the display unit 76, for example. A CPR quick release backrest (not shown) with a cable release backrest adjacent the foot section 26 is also provided. A safety battery back up (not shown) can be used to raise or lower a desired section of the bed and/or the bed height in an emergency.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A bariatric patient management system comprising:
a body supporting main frame having a mattress supporting surface, said main frame including at least one of an extensible side pull out extension and an extensible end pull out extension to increase an area of the mattress supporting surface;
a plurality of ground engaging wheels disposed on said main frame to facilitate a transporting of the bariatric patient management system; and
a plurality of actuators to effect a change in a contour of the mattress supporting surface of said main frame.

2. The bariatric patient management system according to claim 1, wherein said main frame includes a backrest section, a middle section, a leg section, and a foot section.

3. The bariatric patient management system according to claim 2, wherein the actuation of one of said actuators causes an inclination of one of the backrest section, the leg section, and the foot section.

4. The bariatric patient management system according to claim 1, further comprising a trapeze base frame having a two-point mounting configuration.

5. The bariatric patient management system according to claim 4, wherein said trapeze base frame includes a pivotally mounted trapeze boom.

6. The bariatric patient management system according to claim 1, further comprising at least one load cell mounted between said wheels and said main frame, said at least one load cell adapted to provide a weight of the bariatric patient management system.

7. The bariatric patient management system according to claim 1, wherein said actuators are at least one of a push type and a pull type.

8. The bariatric patient management system according to claim 1, wherein said actuators are electric type actuators.

9. The bariatric patient management system according to claim 1, wherein said actuators are hydraulic type actuators.

10. A bariatric patient management system comprising:
a main frame having a backrest section, a middle section, a leg section, and a foot section cooperating to form a mattress supporting surface, each of the backrest section, the middle section, the leg section and the foot section including at least one extensible side pull out extension to increase a width of the mattress supporting surface;
a plurality of ground engaging wheels disposed on said main frame to facilitate a transporting of the bariatric patient management system; and
a plurality of actuators, an actuation of at least one of said actuators causing an inclination of one of the backrest section, the leg section, and the foot section to effect a change in a contour of the mattress supporting surface.

11. The bariatric patient management system according to claim 10, further comprising a trapeze base frame having a two-point mounting configuration.

12. The bariatric patient management system according to claim 11, wherein said trapeze base frame includes a pivotally mounted trapeze boom.

13. The bariatric patient management system according to claim 10, further comprising at least one load cell mounted between said wheels and said main frame, said at least one load cell adapted to provide a weight of the bariatric patient management system.

14. The bariatric patient management system according to claim 10, wherein said main frame includes an extensible end pull out extension to increase a length of the mattress supporting surface.

15. The bariatric patient management system according to claim 10, wherein said actuators are at least one of a push type and a pull type.

16. The bariatric patient management system according to claim 10, wherein said actuators are electric type actuators.

17. The bariatric patient management system according to claim 10, wherein said actuators are hydraulic type actuators.

18. A bariatric patient management system comprising:
a main frame having a first end and a second end;
a backrest section disposed on said main frame adjacent the first end, said backrest section including at least one backrest panel;
a middle section disposed on said main frame adjacent said backrest section, said middle section including at least one middle panel;
a leg section disposed on said main frame adjacent said middle section, said leg section including at least one leg panel;
a foot section disposed on said main frame adjacent the leg section and the second end of said main frame, said foot section including at least one foot panel, the backrest panel, the middle panel, the leg panel, and the foot panel cooperating to form a mattress supporting surface,
a backrest side pull out extension slidingly disposed in a side of the backrest section;
a middle side pull out extension slidingly disposed in a side of the middle section;
a leg side pull out extension slidingly disposed in a side of the leg section;
a foot side pull out extension slidingly disposed in a side of the foot section, said backrest side pull out extension, said middle side pull out extension, said leg side pull out extension, and said foot side pull out extension cooperating to increase a width of the mattress supporting surface;
a plurality of ground engaging wheels disposed on said main frame to facilitate a transporting of the bariatric patient management system;
a backrest actuator linked to said backrest section, an actuation of said backrest actuator causing an inclination of said backrest section;
a leg actuator linked to said leg section, an actuation of said leg actuator causing an inclination of said leg section;
a foot actuator linked to said foot section, an actuation of said foot actuator causing an inclination of said foot section.

19. The bariatric patient management system according to claim 18, wherein said main frame includes a telescoping end pull out extension to increase a length of the mattress supporting surface.

20. The bariatric patient management system according to claim 18, further comprising at least one load cell mounted between said wheels and said main frame, said at least one load cell adapted to provide a weight of the bariatric patient management system.
